(19) United States
(12) Patent Application Publication
(10) Pub. No.: US 2025/0379927 A1
(43) Pub. Date: Dec. 11, 2025

(54) METHOD AND DEVICE FOR SPEEDING UP PACKET PROCESSING

(71) Applicant: MEDIATEK INC., Hsinchu City (TW)

(72) Inventors: Chia-Chi HSIAO, Hsinchu City (TW); Hsin-Hao HUANG, Hsinchu City (TW)

(21) Appl. No.: 18/735,959

(22) Filed: Jun. 6, 2024

(51) Int. Cl. H04L 69/323; H04L 5/00; H04L 69/22; H04L 69/321; H04W 28/06

(52) U.S. Cl. CPC H04L 69/323; H04L 5/0053; H04L 69/22; H04L 69/321; H04W 28/06

(57) ABSTRACT

A method for speeding up packet processing is provided. The method includes: receiving, by a hardware acceleration circuitry of a computing device, a packet from an application layer. The method includes determining, by the hardware acceleration circuitry, whether the packet is a transmission control protocol/Internet protocol (TCP/IP) packet. The method includes performing, by the hardware acceleration circuitry, related processing on the TCP/IP packet to obtain a processed TCP/IP packet after the related processing in response to determining that the packet is the TCP/IP packet. The method includes transmitting, by the hardware acceleration circuitry, the processed TCP/IP packet to a lower layer.

### BACKGROUND OF THE INVENTION

### Field of the Invention

The present disclosure generally relates to processing of packets. More specifically, aspects of the present disclosure relate to a method and a device for speeding up packet processing via hardware.

### Description of the Related Art

Transmission control protocol/Internet protocol (TCP/IP) protocol suite specifies the behavior of how to establish connections, transmit data, and terminate connections in the network. It is the fundamental communication protocol of the Internet.

In conventional networks, the tasks of the upper and intermediate layers are performed in system software. FIG. 1 is a schematic diagram 100 illustrating TCP/IP software 112 implemented by the CPU 110 to perform many layer 3 and layer 4 (e.g., IP and TCP/UDP) processing in the prior art. The TCP/IP software 112 may perform many layer 3 and layer 4 processing including checksum calculation, IP fragmentation, TCP segmentation offload (TSO) and other processing via access of a memory 120 when receiving packets from the application layer 102. Then, the CPU 110 may transmit the packets after the layer 3 and layer 4 processing to the lower layer 104 via the memory 120. In one embodiment, the lower layer 104 may be MAC/RLC/PDCP layers or PHY.

However, these processing performed by the TCP/IP software 112 of the CPU 110 are typically computation intensive, requiring a significant amount of processing overhead. Therefore, there is a need for improved devices and methods for speeding up packet processing to solve this problem.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide devices and methods for speeding up packet processing improve data/packet process time and lower overall power consumption.

In an exemplary embodiment, a method for speeding up packet processing is provided. The method comprises receiving, by a hardware acceleration circuitry of a computing device, a packet from an application layer. The method comprises determining, by the hardware acceleration circuitry, whether the packet is a transmission control protocol/Internet protocol (TCP/IP) packet. The method comprises performing, by the hardware acceleration circuitry, related processing on the TCP/IP packet to obtain a processed TCP/IP packet after the related processing in response to determining that the packet is the TCP/IP packet. The method comprises transmitting, by the hardware acceleration circuitry, the processed TCP/IP packet to a lower layer.

In some embodiments, the related processing is completely performed without memory access.

In some embodiments, the method further comprises transferring, by the hardware acceleration circuitry, the packet to a memory of the computing device and instructing a central processing unit (CPU) of the computing device to perform the related processing on the packet in the memory to obtain a processed non-TCP/IP packet after the related processing in response to determining that the packet is not a TCP/IP packet, and transmitting the processed non-TCP/IP packet to the lower layer by the CPU.

In some embodiments, the related processing comprises: a checksum calculation for TCP/IP packet; an IP fragmentation; and a TCP segmentation offload (TSO).

In some embodiments, the method further comprises filtering out at least one redundant TCP acknowledgment (ACK).

In some embodiments, filtering out at least one redundant TCP ACK comprises: searching a list of queued TCP ACK whose destinations are the lower layer; determining the latest sequence number in the TCP ACKs; and deleting one or more TCP ACKs whose sequence number is earlier than a latest TCP ACK.

In some embodiments, the method further comprises transmitting a pure acknowledgment (ACK) packet in response to determining that the packet is the pure ACK packet; wherein a priority of the pure ACK packet is higher than a priority of a normal packet. In one embodiment, the normal packet is a general network packet, not an empty ACK, an ICMP ping packet, or a QoS packet.

In some embodiments, the method further comprises transmitting a quality of service (QoS) packet in response to determining that the packet is the QoS packet; wherein a priority of the QoS packet is higher than a priority of a normal packet. In one embodiment, the normal packet is a general network packet, not an empty ACK, an ICMP ping packet, or a QoS packet.

In an exemplary embodiment, a device for speeding up packet processing is provided. The device comprises a central processing unit (CPU) and a hardware acceleration processor coupled to the CPU. The hardware acceleration processor is operable to: receive a packet from an application layer; determine whether the packet is a transmission control protocol/Internet protocol (TCP/IP) packet; perform related processing on the TCP/IP packet to obtain a TCP/IP packet after the related processing in response to determining that the packet is the TCP/IP packet; and transmit the processed TCP/IP packet to a lower layer.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram illustrating TCP/IP software implemented by the CPU to perform many layer 3 and layer 4 processing in the prior art.

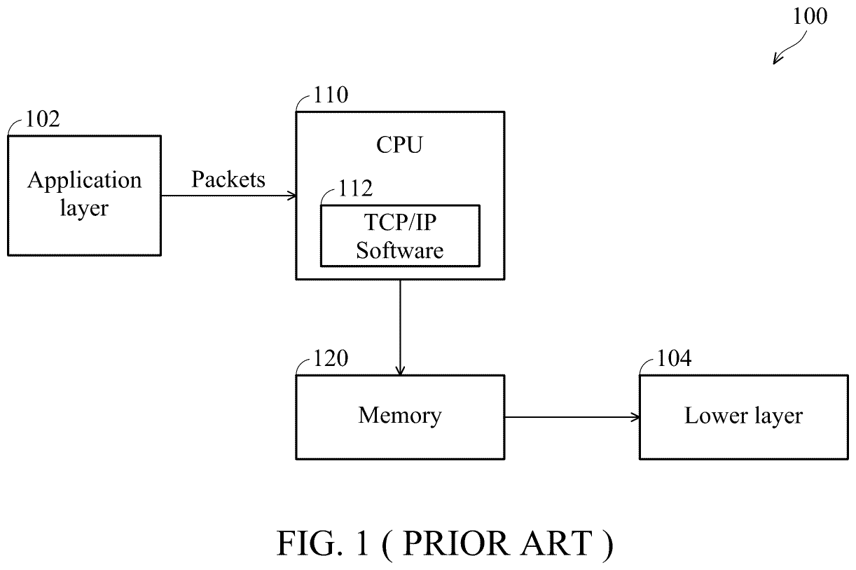

FIG. 2 is a schematic structural diagram illustrating of an application scenario of a method for speeding up packet processing according to an embodiment of the present disclosure.

FIG. 3 is a flow chart illustrating the method for speeding up packet processing according to an embodiment of the disclosure with reference to the schematic structural diagram shown in FIG. 2.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The embodiments of the present disclosure provide a method and device for implementing hardware acceleration in order to resolve the problem of CPU and memory resources being occupied and consumed when the related processing is performed on the TCP/IP packet.

In computing, hardware acceleration generally involves using hardware circuits to perform functions more quickly and efficiently than executing software on general purpose processors.

A hardware acceleration device usually may usually be implemented by a hardware acceleration function module integrated in a CPU or a network adapter.

A hardware acceleration device is usually accessed and used by an application program of a computer device. When the application program of the computer device requires the hardware acceleration device to perform acceleration processing in a service processing process, an instruction related to hardware acceleration is executed using the CPU. The CPU sends data/packets on which hardware acceleration processing needs to be performed to the hardware acceleration device using an interface provided by the hardware acceleration device, and receives data/packets that is obtained after acceleration processing and that is returned by the hardware acceleration device. The application program processes a service using the CPU. In practical application, various application programs call different hardware acceleration devices by executing different tasks, to implement the hardware acceleration processing. Therefore, for clear description of technical solutions provided in the embodiments of the present disclosure, in the embodiments of the present disclosure, a process in which the various application programs implement hardware acceleration processing using a CPU is described using an example in which the CPU initiates a hardware acceleration request and receives data/packets obtained after the hardware acceleration processing.

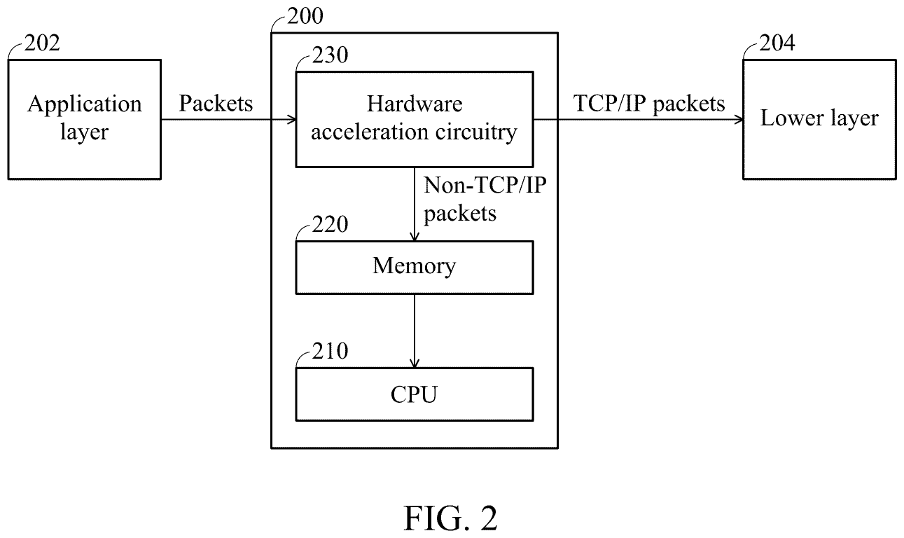

FIG. 2 is a schematic structural diagram illustrating of an application scenario of a method for speeding up packet processing according to an embodiment of the present disclosure. As shown in FIG. 2, a computing device 200 includes a CPU 210, a memory 220 and a hardware acceleration circuitry 230. The CPU 210 and the hardware acceleration circuitry 230 are connected to the memory 220.

It should be noted that, in FIG. 2, the hardware acceleration circuitry 230 may be implemented using the foregoing hardware acceleration device or may be implemented using another device or module with a hardware acceleration function. In addition, FIG. 2 is only an example for illustrating a structure and composition of a computer device. In further implementation, the computing device 200 may further include another component, such as a hard disk or a graphics card. This embodiment of the present disclosure constitutes no limitation on other composition and structure further included by the computing device 200 in further implementation.

When the hardware acceleration circuitry 230 receives a packet from an application layer 202, the hardware acceleration circuitry 230 may determines whether the packet is a transmission control protocol/Internet protocol (TCP/IP) packet.

In response to determining that the packet is the TCP/IP packet, the hardware acceleration circuitry 230 performs related processing on the TCP/IP packet directly without memory crossing. The hardware acceleration circuitry 230 then transmits the processed TCP/IP packet to a lower layer 204. In other words, the related processing is completely performed without memory access. The packet received from an application layer 202 may be processed by hardware directly and then immediately transferred to the lower layer.

In response to determining that the packet is not a TCP/IP packet, the hardware acceleration circuitry 230 transfers the packet to the memory 220 and instructs the CPU 210 to perform the related processing on the packet in the memory 220 to obtain a processed non-TCP/IP packet after the related processing. Then, the CPU 210 transmits the processed non-TCP/IP packet to the lower layer 204 for further processing through software or hardware.

In one embodiment, the related processing at least comprises a checksum calculation for TCP/IP packet, an IP fragmentation, a TCP segmentation offload (TSO) and so on. Specifically, the hardware acceleration circuitry 230 may implement the Internet layer and the transport layer in TCP/IP protocols to improve data/packet process time and lower overall power consumption.

When the packet received from an application layer 202 are processed via the hardware acceleration circuitry 230 directly, the hardware acceleration circuitry 230 may be employed to offload the checksum calculation tasks from the software stack to hardware units. The hardware acceleration circuitry 230 also may handle IP fragmentation tasks efficiently and manage the segmentation and reassembly of IP packets optimally without software intervention. The TSO offloads the segmentation of large TCP segments into smaller packets to the network interface hardware.

In addition, even though the hardware acceleration circuitry 230 is described herein as utilized in the context of the computing device 200 in FIG. 2, in other implementations, embodiments of the hardware acceleration circuitry 230 can also be used in a standalone server, desktop computer, laptop computer, or other suitable types of computing device.

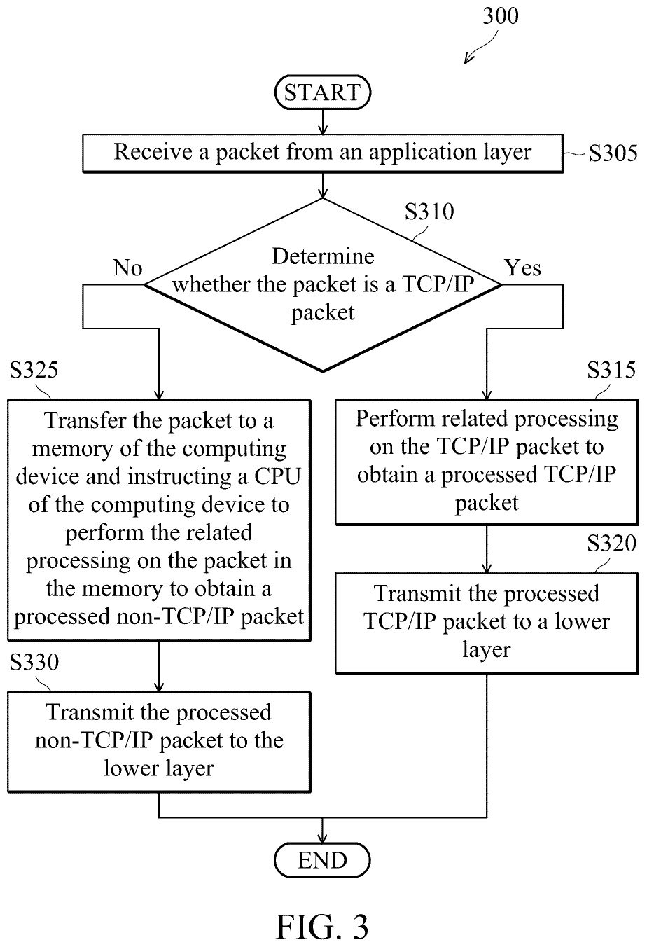

FIG. 3 is a flow chart 300 illustrating the method for speeding up packet processing according to an embodiment of the disclosure with reference to the schematic structural diagram shown in FIG. 2.

In step S305, the hardware acceleration circuitry receives a packet from an application layer.

Then, in step S310, the hardware acceleration circuitry determines whether the packet is a transmission control protocol/Internet protocol (TCP/IP) packet.

Next, in response to determining that the packet is the TCP/IP packet (“Yes” in step S310), in step S315, the hardware acceleration circuitry performs related processing on the TCP/IP packet to obtain a TCP/IP packet after the related processing, wherein the related processing is completely performed without memory access.

In step S320, the hardware acceleration circuitry transmits the TCP/IP packet after the related processing to a lower layer.

The method returns to step S310. In response to determining that the packet is not a TCP/IP packet (“No in step S310”), in step S325, the hardware acceleration circuitry transfers the packet to a memory and instructs the CPU to perform the related processing on the packet in the memory to obtain a non-TCP/IP packet after the related processing.

In step S330, the CPU transmits the non-TCP/IP packet after the related processing to the lower layer.

In one embodiment, the hardware acceleration circuitry may further filter out at least one redundant TCP acknowledgment (ACK) to save bandwidth for transmitting packets and processing burden of the lower layer. Specifically, the hardware acceleration circuitry may search a list of queued TCP ACK whose destinations are the lower layer, determine the latest sequence number in the TCP ACKs, and delete one or more TCP ACKs whose sequence number is earlier than a latest TCP ACK.

In one embodiment, the hardware acceleration circuitry may transmit a pure acknowledgment (ACK) packet in response to determining that the packet is the pure ACK packet, wherein a priority of the pure ACK packet is higher than a priority of a normal packet.

In one embodiment, the hardware acceleration circuitry may transmit a quality of service (QoS) packet in response to determining that the packet is the QoS packet, wherein a priority of the QoS packet is higher than a priority of a normal packet.

In the method and device for speeding up packet processing provided in the embodiments of the present disclosure, the hardware acceleration circuitry performs the related processing on the TCP/IP packet for speeding up the process time and then transfers the packet to the lower layer directly without any memory crossing. In this way, the method and device for speeding up packet processing can be helpful for overall power consumption optimization and memory footprint reduction.

A person of ordinary skill in the art may be aware that, the units and steps in the examples described with reference to the embodiments disclosed herein may be implemented by electronic hardware, computer software, or a combination thereof. To clearly describe the interchangeability between the hardware and the software, the foregoing has usually described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing device and unit, reference may be made to a corresponding process in the foregoing method embodiments, and details are not described herein.

In the several embodiments provided in this application, it should be understood that the disclosed device and method may be implemented in other manners. For example, the described device embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the other approaches, or all or a part of the technical solutions may be implemented in the form of a software product. The software product is stored in a storage medium and includes several instructions for instructing a computer device (which may be a personal computer, a server, or a network device) to perform all or a part of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for speeding up packet processing, comprising:
receiving, by a hardware acceleration circuitry of a computing device, a packet from an application layer;
determining, by the hardware acceleration circuitry, whether the packet is a transmission control protocol/Internet protocol (TCP/IP) packet;
performing, by the hardware acceleration circuitry, related processing on the TCP/IP packet to obtain a processed TCP/IP packet after the related processing in response to determining that the packet is the TCP/IP packet; and
transmitting, by the hardware acceleration circuitry, the processed TCP/IP packet to a lower layer.

2. The method for speeding up packet processing as claimed in claim 1, wherein the related processing is completely performed without memory access.

3. The method for speeding up packet processing as claimed in claim 1, further comprising:
transferring, by the hardware acceleration circuitry, the packet to a memory of the computing device and instructing a central processing unit (CPU) of the computing device to perform the related processing on the packet in the memory to obtain a processed non-TCP/IP packet after the related processing in response to determining that the packet is not a TCP/IP packet; and
transmitting the processed non-TCP/IP packet to the lower layer by the CPU.

4. The method for speeding up packet processing as claimed in claim 1, wherein the related processing at least comprises:
a checksum calculation for TCP/IP packet;
an IP fragmentation; and
a TCP segmentation offload (TSO).

5. The method for speeding up packet processing as claimed in claim 1, further comprising:
filtering out at least one redundant TCP acknowledgment (ACK).

6. The method for speeding up packet processing as claimed in claim 5, wherein filtering out at least one redundant TCP ACK comprises:
searching a list of queued TCP ACK whose destinations are the lower layer;
determining the latest sequence number in the TCP ACKs; and
deleting one or more TCP ACKs whose sequence number is earlier than a latest TCP ACK.

7. The method for speeding up packet processing as claimed in claim 1, further comprising:
transmitting a pure acknowledgment (ACK) packet in response to determining that the packet is the pure ACK packet;
wherein a priority of the pure ACK packet is higher than a priority of a normal packet.

8. The method for speeding up packet processing as claimed in claim 1, further comprising:
transmitting a quality of service (QoS) packet in response to determining that the packet is the QoS packet;
wherein a priority of the QoS packet is higher than a priority of a normal packet.

9. A device for speeding up packet processing, comprising:
a central processing unit (CPU); and
a hardware acceleration processor coupled to the CPU, wherein the hardware acceleration processor is operable to:
receive a packet from an application layer;
determine whether the packet is a transmission control protocol/Internet protocol (TCP/IP) packet;
perform related processing on the TCP/IP packet to obtain a processed TCP/IP packet after the related processing in response to determining that the packet is the TCP/IP packet; and
transmit the processed TCP/IP packet to a lower layer.

10. The device for speeding up packet processing as claimed in claim 9, wherein the related processing is completely performed without memory access.

11. The device for speeding up packet processing as claimed in claim 9, wherein the device further comprises:
a memory, coupled to the CPU and the hardware acceleration processor;
wherein the hardware acceleration processor is further operable to:
transfer the packet to the memory and instructing the CPU to perform the related processing on the packet in the memory to obtain a processed non-TCP/IP packet after the related processing in response to determining that the packet is not a TCP/IP packet; and
wherein the CPU is operable to:
transmit the processed non-TCP/IP packet to the lower layer.

12. The device for speeding up packet processing as claimed in claim 9, wherein the related processing at least comprises:
a checksum calculation for TCP/IP packet;
an IP fragmentation; and
a TCP segmentation offload (TSO).

13. The device for speeding up packet processing as claimed in claim 9, further comprising:
filtering out at least one redundant TCP acknowledgment (ACK).

14. The device for speeding up packet processing as claimed in claim 13, wherein filtering out at least one redundant TCP ACK comprises:
searching a list of queued TCP ACK whose destinations are the lower layer;
determining the latest sequence number in the TCP ACKs; and
deleting one or more TCP ACKs whose sequence number is earlier than a latest TCP ACK.

15. The device for speeding up packet processing as claimed in claim 9, further comprising:
transmitting a pure acknowledgment (ACK) packet in response to determining that the packet is the pure ACK packet;
wherein a priority of the pure ACK packet is higher than a priority of a normal packet.

16. The device for speeding up packet processing as claimed in claim 9, further comprising:
transmitting a quality of service (QoS) packet in response to determining that the packet is the QoS packet;
wherein a priority of the QoS packet is higher than a priority of a normal packet.
